(19) United States
(12) Patent Application Publication
(10) Pub. No.: US 2026/0358200 A1
(43) Pub. Date: Nov. 12, 2026

(54) TEST METHOD AND TEST APPARATUS FOR CONTROLLER OF VEHICLE AIR SPRING, DEVICE, AND MEDIUM

(71) Applicant: CHONGQING CHANGAN AUTOMOBILE CO., LTD., Chongqing (CN)

(72) Inventors: Jiangang LI, Chongqing (CN); Peng CHENG, Chongqing (CN); Xudong DU, Chongqing (CN)

(73) Assignee: CHONGQING CHANGAN AUTOMOBILE CO., LTD., Chongqing (CN)

(21) Appl. No.: 19/713,878

(22) Filed: Jun. 19, 2026

Related U.S. Application Data
(63) Continuation of application No. PCT/CN2024/143468, filed on Dec. 27, 2024.

(30) Foreign Application Priority Data
Jan. 3, 2024 (CN) 202410014507.6

(51) Int. Cl. G01M 17/04; G07C 5/08

(52) U.S. Cl. CPC G01M 17/04; G07C 5/0808

(57) ABSTRACT

A testing method for a controller of a vehicle air spring includes: obtaining the vehicle height data and preset target height data; changing an opened/closed state of a height adjustment valve based on the vehicle height data and the target height data; obtaining opened/closed state information of the height adjustment valve; and operating the stepper motor to change the sensor height; the controller stopping changing the opened/closed state of the height adjustment valve, when the vehicle height data is equal to the target height data; obtaining the vehicle height data and the target height data; and determining whether a difference therebetween is within a preset threshold range; and the first host computer determining that the controller of the air spring is working properly when the difference is within the preset threshold range.

### CROSS-REFERENCE TO RELATED APPLICATIONS

The present application is a continuation application of the international patent application No. PCT/CN2024/143468, filed on Dec. 27, 2024, which claims the priority of the Chinese patent application No. 202410014507.6, filed on Jan. 3, 2024, contents of which are incorporated herein by its entireties.

### TECHNICAL FIELD

Embodiments of the present disclosure relate to the technical field of vehicles, and more specifically, to a test method for a controller of a vehicle air spring, and a test apparatus for a controller of a vehicle air spring, an electronic device, and a computer-readable medium.

### BACKGROUND

Before vehicle assembly is completed, a functional test needs to be performed on a controller of an air spring, so as to determine whether the controller can properly control the air spring to adjust a height of the vehicle. A vehicle air spring may include at least two host computers (CANAPE), a controller, a sensor, and a five-way valve. The two host computers may be communicatively connected to the controller, and the controller may be communicatively connected to the sensor and the five-way valve. One of the two host computers may collect opened/closed state information of the five-way valve and send the opened/closed state information to the controller. The sensor may collect vehicle height data and send the vehicle height data to the controller. The controller may control the five-way valve to be opened or closed based on the vehicle height data and a target vehicle height, such that inflation and deflation of the five-way valve may be achieved, and the vehicle height may be adjusted. The other one of the two host computers may send a controller area network (CAN) signal to the controller, and the CAN signal may include vehicle driving data. Only when the vehicle driving data is within a proper range, the controller may control the five-way valve to be opened and closed.

In a bench test environment for testing functions of the controller, the opening and closing of the five-way valve may not directly change the vehicle height. In order to perform the test, a test operator may need to manually change a height of the sensor according to the opening and closing of the five-way valve, such that the vehicle height data collected by the sensor may be changed. In addition, the test operator may need to manually control the other host computer to send the CAN signal to the controller. However, such operation may result in the test operator being unable to accurately manually adjust the sensor height according to the opening and closing of the five-way valve.

### SUMMARY

The present disclosure provides a testing method for a controller of a vehicle air spring, applied to a test system for the controller of the vehicle air spring. The test system for the controller of the vehicle air spring at least includes an air spring, a stepper motor, and a first host computer communicatively connected to the air spring. The air spring at least includes a controller, a sensor, and a height adjustment valve; the controller being configured to control the height adjustment valve. The stepper motor is connected to the sensor; the sensor is configured to collect vehicle height data. The method includes:

Obtaining, by the controller from the air spring, the vehicle height data and preset target height data;

Changing, by the controller, an opened/closed state of the height adjustment valve based on the vehicle height data and the target height data;

Obtaining, by the first host computer from the air spring, opened/closed state information of the height adjustment valve; and operating, based on the opened/closed state information, the stepper motor to change the height of the sensor;

The controller stopping changing the opened/closed state of the height adjustment valve, when the vehicle height data obtained by the controller from the sensor being equal to the target height data;

Obtaining, by the first host computer from the air spring, the vehicle height data and the target height data; and determining whether a difference between the vehicle height data and the target height data is within a preset threshold range; and

The first host computer determining that the controller of the air spring is working properly, when the difference between the vehicle height data and the target height data being within the preset threshold range.

The present disclosure provides a test apparatus for a controller of a vehicle air spring, applied to a test system for the controller of the vehicle air spring. The test system for the controller of the vehicle air spring at least includes an air spring, a stepper motor, and a first host computer communicatively connected to the air spring. The air spring at least includes a controller, a sensor, and a height adjustment valve. The controller is configured to control the height adjustment valve; the stepper motor is connected to the sensor; the sensor is configured to collect vehicle height data. The test apparatus includes:

An obtaining module, configured to cause the controller to obtain, from the air spring, the vehicle height data and preset target height data;

A changing module, configured to cause the controller to change an opened/closed state of the height adjustment valve based on the vehicle height data and the target height data;

A first opened/closed state information obtaining module, configured to cause the first host computer to: obtain opened/closed state information of the height adjustment valve from the air spring; and operate, based on the opened/closed state information, the stepper motor to change the height of the sensor;

A stop changing module, configured to cause, when the vehicle height data obtained by the controller from the sensor being equal to the target height data, the controller to stop changing the opened/closed state of the height adjustment valve;

A vehicle height data and target height data obtaining module, configured to cause the first host computer to: obtain the vehicle height data and the target height data from the air spring; and determine whether a difference between the vehicle height data and the target height data is within a preset threshold range;

A first determination module, configured to cause, when the difference between the vehicle height data and the target height data is within the preset threshold range, the first host computer to determine that the controller of the air spring is working properly.

The present disclosure provides an electronic device, including a processor, a communication interface, a memory, and a communication bus. The processor, the communication interface, and the memory communicate with each other via the communication bus.

The memory is configured to store computer programs.

The processor is configured to execute the programs stored in the memory to implement the method in the embodiments of the present disclosure.

The present disclosure provides one or more computer-readable media, having instructions stored thereon. The instructions, when being executed by one or more processors, cause the processors to execute the method in the embodiments of the present disclosure.

The present disclosure provides a test system for a controller of a vehicle air spring, at least comprising an air spring, a stepper motor, and a first host computer communicatively connected to the air spring; the air spring at least comprising a controller, a sensor, and a height adjustment valve; the controller being configured to control the height adjustment valve; the stepper motor being connected to the sensor; the sensor being configured to collect vehicle height data.

The test system for the controller of the vehicle air spring further includes a processor, a communication interface, a memory, and a communication bus. The processor, the communication interface, and the memory communicate with each other via the communication bus.

The memory is configured to store computer programs.

The processor is configured to execute the programs stored in the memory to implement a testing method for the controller of the vehicle air spring, and the testing method includes:
The controller obtaining, from the air spring, the vehicle height data and preset target height data;
The controller changing an opened/closed state of the height adjustment valve based on the vehicle height data and the target height data;
The first host computer obtaining, from the air spring, opened/closed state information of the height adjustment valve; and operating, based on the opened/closed state information, the stepper motor to change the height of the sensor;
When the vehicle height data obtained by the controller from the sensor being equal to the target height data, the controller stopping changing the opened/closed state of the height adjustment valve;
The first host computer obtaining, from the air spring, the vehicle height data and the target height data; and determining whether a difference between the vehicle height data and the target height data is within a preset threshold range; and
When the difference between the vehicle height data and the target height data being within the preset threshold range, the first host computer determining that the controller of the air spring is working properly.

### BRIEF DESCRIPTION OF THE DRAWINGS

FIG. 1 is a schematic diagram of a bench test environment for testing a controller of a vehicle air spring in the related art.

FIG. 2 is a flow chart of a testing method for a controller of a vehicle air spring according to an embodiment of the present disclosure.

FIG. 3 is a schematic diagram of a sensor according to an embodiment of the present disclosure.

FIG. 4 is a schematic diagram of a stepper motor according to an embodiment of the present disclosure.

FIG. 5 is a schematic diagram of test results output by a first host computer according to an embodiment of the present disclosure.

FIG. 6 is a structural block diagram of a test system for testing a controller of a vehicle air spring according to an embodiment of the present disclosure.

FIG. 7 is a structural block diagram of a test apparatus for a controller of a vehicle air spring according to an embodiment of the present disclosure.

FIG. 8 is a block diagram of an electronic device according to an embodiment of the present disclosure.

FIG. 9 is a schematic diagram of a computer-readable medium according to an embodiment of the present disclosure.

### DETAILED DESCRIPTIONS

In order to make the above objects, features, and advantages of the present disclosure more apparent and understandable, the present disclosure will be further described in detail below by referring to the accompanying drawings and specific embodiments.

In order to facilitate understanding the technical solutions and technical effects of the embodiments of the present disclosure, a brief description of the related art of the present disclosure may be provided below.

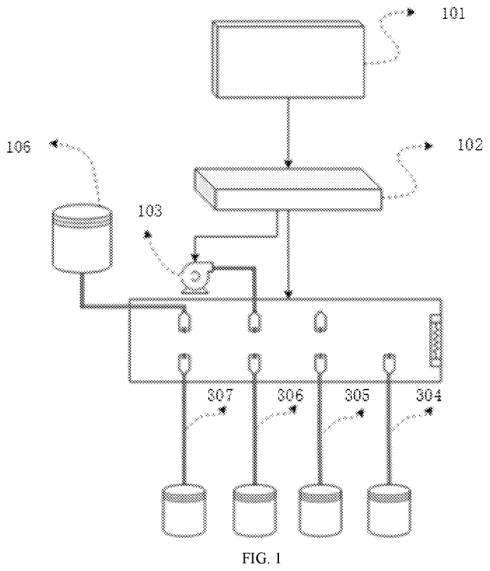

As shown in FIG. 1, a schematic diagram of a bench test environment for testing a controller of a vehicle air spring in the related art is shown. In the art, the bench test environment for testing functions of the controller of the vehicle air spring may include two host computers, an electronic control unit (ECU) controller, a corner air bag valves, a compressor, and an air reservoir. In FIG. 1, the reference numeral 101 may indicate the host computers, the reference numeral 102 may indicate the ECU controller, the reference numeral 103 may indicate the corner air bag valve, the reference numeral 106 may indicate the air reservoir, and reference numerals 304-307 may indicate corner air bag valves. A rectangle above the corner air bag valve may indicate a sensor.

The two host computers may both be communicatively connected to the ECU controller, and the ECU controller may be communicatively connected to the sensors and the corner air bag valves. One of the two host computers may collect opened/closed state information of each corner air bag valve and send the opened/closed state information to the ECU controller. The sensor may collect vehicle height data and send the vehicle height data to the ECU controller. The ECU controller may control the corner air bag valve to be opened or closed based on the vehicle height data and target height data, and the compressor or the air reservoir may be used to achieve inflation and deflation of the corner air bag valve. The other one of the two host computers may send a CAN signal to the ECU controller, and the CAN signal may include vehicle driving data. Only when the vehicle driving data is within a proper range, the ECU controller may control the corner air bag valve to be opened or closed.

Opening and closing of the corner air bag valve may not directly change the vehicle height. In order to perform the test, a test operator may need to manually change a height of the sensor according to the opening and closing of the corner air bag valve, such that the vehicle height data collected by the sensor may be changed. In addition, the test operator may need to manually control the other one of the two host computers to send the CAN signal to the ECU controller. However, such operation may result in the test operator being unable to accurately manually adjust the height of the sensor according to the opening and closing of the corner air bag valve.

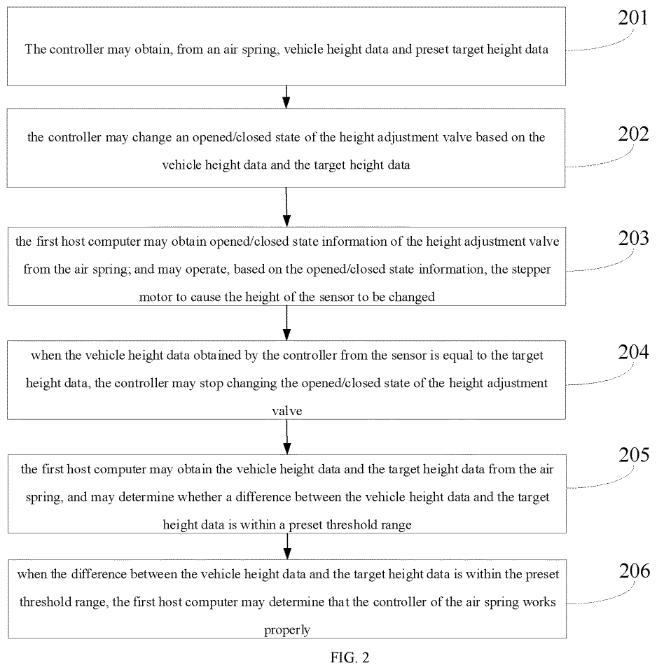

As shown in FIG. 2, a flow chart of a testing method for a controller of a vehicle air spring according to an embodiment of the present disclosure is shown. The method may be applied to a test system for the controller of the vehicle air spring. The test system for the controller of the vehicle air spring may at least include an air spring, a stepper motor, and a first host computer communicatively connected to the air spring. The air spring may at least include a controller, a sensor, and a height adjustment valve. The controller may be configured to control the height adjustment valve. The stepper motor may be connected to the sensor. The sensor may be configured to collect vehicle height data. The method may specifically include the following blocks.

In a block 201, a controller may obtain, from an air spring, vehicle height data and preset target height data.

In the embodiment of the present disclosure, the test system for the controller of the vehicle air spring may include a first host computer, the air spring, and a stepper motor. The air spring may at least include the controller, a second host computer, a third host computer, a sensor, and a height adjustment valve. The sensor may be configured to collect a vehicle height. The height adjustment valve in the test system for the controller of the vehicle air spring may achieve inflation and deflation of the height adjustment valve through opening and closing the height adjustment valve. However, the inflation and deflation of the height adjustment valve may not change the vehicle height. In the embodiment of the present disclosure, the height adjustment valve may be a five-way valve. The controller of the air spring may be integrated on a vehicle motion control (VMC) integrated circuit board. Before the VMC integrated circuit board is assembled on the vehicle, the test system for the controller of the vehicle air spring provided by the embodiment of the present disclosure may be configured to test whether the controller is working properly.

The first host computer may be communicatively connected to the controller, the second host computer, and the third host computer in the air spring. The first host computer may be communicatively connected to the stepper motor, and the stepper motor may be connected to the sensor. The first host computer may control the stepper motor to rotate, so as to change a height of the sensor, such that the vehicle height data collected by the sensor may be changed. The controller in the air spring may be communicatively connected to the second host computer, the third host computer, the sensor, and the height adjustment valve. The controller may control the height adjustment valve to be switched between an opened state and a closed state.

In the embodiment of the present disclosure, the controller may obtain the vehicle height data and the target height data from the air spring. In an example, the sensor may be communicatively connected to the controller, and the sensor may send the collected vehicle height data to the controller. The second host computer may send the target height data to the air spring to change a mode of the air spring. In different modes, the target height data to be adjusted by the controller may be different.

In a block 202, the controller may change an opened/closed state of the height adjustment valve based on the vehicle height data and the target height data.

In the embodiment of the present disclosure, the controller can adjust the height adjustment valve to be opened or closed based on the vehicle height data sent by the sensor and the target height data sent by the second host computer, such that inflation and deflation of the height adjustment valve may be achieved.

In a block 203, the first host computer may obtain opened/closed state information of the height adjustment valve from the air spring; and may operate, based on the opened/closed state information, the stepper motor to cause the height of the sensor to be changed.

In the embodiment of the present disclosure, the second host computer in the air spring may collect the opened/closed state information of the height adjustment valve and send the opened/closed state information of the height adjustment valve to the first host computer.

In the embodiment of the present disclosure, the inflation and deflation of the height adjustment valve caused by the change in the opened/closed state information may not change the vehicle height. In order to achieve testing of the controller of the vehicle air spring, the first host computer may control, according to the opened/closed state information of the height adjustment valve, the stepper motor to rotate, so as to change the height of the sensor. In the embodiment of the present disclosure, as the height of the sensor changes, the vehicle height data collected by the sensor may change accordingly.

In a block 204, when the vehicle height data obtained by the controller from the sensor is equal to the target height data, the controller may stop changing the opened/closed state of the height adjustment valve.

In the embodiment of the present disclosure, the controller may change the opened/closed state of the height adjustment valve based on the target height data and the vehicle height data. The first host computer may control, according to the opened/closed state information of the height adjustment valve, the stepper motor to rotate, so as to change the vehicle height data collected by the sensor.

When the vehicle height data received by the controller from the sensor is equal to the target height data, the controller may stop changing the opened/closed state of the height adjustment valve, and the first host computer may accordingly stop controlling the stepper motor to rotate. In this way, the height of the sensor may no longer change, meaning that the vehicle height may no longer change.

In a block 205, the first host computer may obtain the vehicle height data and the target height data from the air spring, and may determine whether a difference between the vehicle height data and the target height data is within a preset threshold range.

In the embodiment of the present disclosure, when the controller stops changing the opened/closed state of the height adjustment valve and the first host computer stops controlling the stepper motor to rotate, the first host computer may obtain the vehicle height data from the air spring. The vehicle height data may be collected by the sensor when the controller stops changing the opened/closed state of the height adjustment valve. In an example, when the controller in the air spring stops changing the opened/closed state of the height adjustment valve, the controller may receive the vehicle height data from the sensor, and the second host computer may collect the vehicle height data and send the vehicle height data to the first host computer.

The first host computer may calculate the difference between the vehicle height data collected by the sensor and the target height data, when the controller stops changing the opened/closed state of the height adjustment valve; and may determine whether the difference is within the preset threshold range. The preset threshold range may refer to an error value unrelated to internal logic control of the controller.

In a block 206, when the difference between the vehicle height data and the target height data is within the preset threshold range, the first host computer may determine that the controller of the air spring works properly.

In the embodiment of the present disclosure, when the controller stops changing the opened/closed state of the height adjustment valve, and when the difference between the vehicle height data collected by the sensor and the target height data is within the preset threshold range, the first host computer may determine that the controller of the air spring works properly. When the controller stops changing the opened/closed state of the height adjustment valve, and when the difference between the vehicle height data collected by the sensor and the target height data is not within the preset threshold range, the first host computer may determine that the controller of the air spring is not working properly. In an example, after the second host computer sends the target height data to the controller, the controller may not change the mode of the air spring, and the target height data stored in the controller may not be changed to the target height data sent by the second host computer. In this case, when the controller stops changing the opened/closed state of the height adjustment valve, the difference between the vehicle height data collected by the sensor and the target height data may be out of the preset threshold range, and the first host computer may determine that the controller of the air spring is not working properly, and the first host computer may output a failed test result.

In the embodiment of the present disclosure, the controller may obtain the vehicle height data and the target height data from the air spring; the controller may change the opened/closed state of the height adjustment valve based on the vehicle height data and the target height data; the first host computer may obtain the opened/closed state information of the height adjustment valve from the air spring and may operate, based on the opened/closed state information, the stepper motor to cause the height of the sensor to be changed. When the vehicle height data obtained by the controller from the sensor is equal to the target height data, the controller may stop changing the opened/closed state of the height adjustment valve. The first host computer may obtain the vehicle height data from the air spring, and may determine whether the difference between the vehicle height data and the target height data is within the preset threshold range. When the difference between the vehicle height data and the target height data is within the preset threshold range, the first host computer may determine that the controller of the air spring is working properly. In the embodiment of the present disclosure, the first host computer may drive the stepper motor to rotate based on the opened/closed state information of the height adjustment valve, so as to change the height of the sensor, avoiding errors caused by an operator manually adjusting the height of the sensor according to the opened/closed state of the height adjustment valve.

Further, in any of the above embodiments, the air spring may further include the second host computer. The second host computer may be communicatively connected to the controller. The method may further include the following.

In a sub-block S11, the first host computer may obtain driving data from the air spring, and may determine whether the driving data is within a preset data range.

In a sub-block S12, when the driving data is within the preset data range, the first host computer may send a first instruction to the second host computer. The first instruction may be configured to instruct the second host computer to send the target height data to the controller.

In a sub-block S13, the second host computer may receive the first instruction, and may send, based on the first instruction, the target height data to the controller.

In the embodiment of the present disclosure, the air spring may further include the second host computer, and the second host computer may be communicatively connected to the controller and the first host computer. The controller in the air spring may store the vehicle driving data. The first host computer may obtain the vehicle driving data stored in the controller. The vehicle driving data may include a lateral acceleration of the vehicle, a longitudinal acceleration of the vehicle, a steering angle of the vehicle, a speed of the vehicle, and so on. In an example, the second host computer may collect the vehicle driving data stored in the controller and send the collected vehicle driving data to the first host computer.

In the embodiment of the present disclosure, the first host computer may determine whether the vehicle driving data is within the preset data range. During vehicle operation, when the driving data exceeds the preset data range, safety risks may be caused if the air spring controller adjusts the vehicle height by controlling the inflation and deflation of the height adjustment valve. Therefore, the preset data range may refer to a safe driving data range within which the air spring controller may adjust the vehicle height during vehicle operation.

In the embodiment of the present disclosure, when the vehicle driving data is within the preset data range, the first host computer may send the first instruction to the second host computer to instruct the second host computer to send the target height data to the controller, so as to change the mode of the air spring. In different modes of the air spring, the target height data to be adjusted by the controller may be different. The controller may change the height adjustment valve to be opened or closed based on the vehicle height data sent by the sensor and the target height data sent by the second host computer, such that inflation and deflation of the height adjustment valve may be achieved.

Further, in any of the above embodiments, the sub-block S11 may further include the following.

In a sub-block S21, the second host computer may collect the driving data from the controller, and may send the driving data to the first host computer.

In a sub-block S22, the first host computer may receive the driving data sent by the second host computer.

In the embodiment of the present disclosure, the air spring may further include the second host computer, and the second host computer may be communicatively connected to the controller and the first host computer. The second host computer may collect the vehicle driving data stored in the controller and send the collected vehicle driving data to the first host computer. The first host computer may receive the driving data sent by the second host computer and may determine whether the driving data is within the preset data range. Only when the driving data is within the preset data range, the controller may change the opened/closed state of the height adjustment valve.

The driving data may include: the lateral acceleration of the vehicle, the longitudinal acceleration of the vehicle, the steering angle of the vehicle, the speed of the vehicle, and so on. The preset data range may refer to the safe driving data range within which the air spring controller may adjust the vehicle height during vehicle operation.

Further, in any of the above embodiments, the air spring may further include the third host computer. The third host computer may be communicatively connected to the controller. The block 202 may further include the following.

In a sub-block S31, when the driving data is not within the preset data range, the first host computer may send a second instruction to the third host computer. The second instruction may be configured to instruct the third host computer to send preset driving data that is within the data range to the controller.

In a sub-block S32, the third host computer may receive the second instruction, and may send, based on the second instruction, the preset driving data that is within the data range to the controller.

In a sub-block S33, when the controller receives the driving data that is within the data range, the controller may change the opened/closed state of the height adjustment valve based on the vehicle height data and the target height data.

In the embodiment of the present disclosure, the air spring may further include the third host computer. The third host computer may be communicatively connected to the first host computer and the controller. When the driving data stored in the controller is not within the preset data range, the controller may not change the opened/closed state of the height adjustment valve. The first host computer may send a second instruction to the third host computer to instruct the third host computer to send the CAN signal to the controller. The CAN signal may store the driving data that is within the preset data range.

The third host computer may receive the second instruction and send the CAN signal to the controller based on the second instruction. When the controller receives the CAN signal, the controller can change the opened/closed state of the height adjustment valve based on the vehicle height data and the target height data, achieving inflation and deflation of the height adjustment valve. The vehicle height data may be collected by the sensor and sent to the controller. The target height data may be sent by the second host computer to the controller. The second host computer may send the target height data to the controller to change the air spring mode. In different modes of the air spring, the target height data to be adjusted by the controller may be different.

In the embodiment of the present disclosure, the third host computer may send the CAN signal to the controller based on the instruction from the first host computer, avoiding the situation where the test operator manually changes the height of the sensor according to the height adjustment valve being opened or closed and simultaneously manually controls the third host computer to send the CAN signal to the controller, such that the situation, where the test operator is unable to accurately manually adjust the height of the sensor according to the height adjustment valve being opened or closed, may be prevented.

Further, in any of the above embodiments, the method may further include the following.

In a sub-block S41, when the controller receives the driving data that is within the data range, the first host computer may determine, based on the opened/closed state information, whether the opened/closed state of the height adjustment valve is changed.

In a sub-block S42, when the opened/closed state of the height adjustment valve is changed, the first host computer may determine that the controller of the air spring works properly.

In the embodiment of the present disclosure, the second host computer may be communicatively connected to the first host computer. The second host computer may collect the opened/closed state information of the height adjustment valve and send the opened/closed state information to the first host computer.

When the controller receives the CAN signal, the controller may change the opened/closed state of the height adjustment valve based on the vehicle height data and the target height data. The CAN signal may include the driving data within the safe driving data range. When the controller receives the CAN signal, the first host computer may determine, based on the opened/closed state information of the height adjustment valve sent by the second host computer, whether the opened/closed state of the height adjustment valve is changed. When the opened/closed state of the height adjustment valve is changed, the first host computer may determine that the controller of the air spring works properly. When the opened/closed state of the height adjustment valve is not changed, the first host computer may determine that the controller of the air spring does not work properly.

Further, in any of the above embodiments, the block 205 may further include the following.

In a sub-block S51, the second host computer may collect the vehicle height data and the target height data from the controller, and may send the vehicle height data and the target height data to the first host computer.

In a sub-block S52, the first host computer may receive the vehicle height data and the target height data sent by the second host computer.

In the embodiment of the present disclosure, the second host computer may be communicatively connected to the first host computer and the controller. The second host computer can collect the vehicle height data and the target height data stored in the controller, and send the vehicle height data and the target height data to the first host computer. The first host computer may receive the vehicle height data and the target height data. In an example, the controller may store the vehicle height data, which may be collected by the sensor when the controller stops changing the opened/closed state of the height adjustment valve. The second host computer may collect the vehicle height data and send the vehicle height data to the first host computer. The first host computer may receive the vehicle height data and may calculate the difference between the target height data and the vehicle height data that is collected by the sensor when the controller stops changing the opened/closed state of the height adjustment valve. The first host computer may determine whether the difference is within the preset threshold range, so as to determine whether the controller of the air spring works properly.

Further, in any of the above embodiments, the controller may further store a control parameter. The method may further include the following.

In a sub-block S61, when the difference between the vehicle height data and the target height data is not within the preset threshold range, and/or when the opened/closed state of the height adjustment valve is changed, the first host computer may determine that the control parameter is incorrect.

In a sub-block S62, the first host computer may send a second instruction to the second host computer. The second instruction may be configured to instruct the second host computer to send a correct preset control parameter to the controller.

In a sub-block S63, the second host computer may receive the second instruction, and may send, based on the second instruction, the correct preset control parameter to the controller.

In the embodiment of the present disclosure, the controller further may store the control parameter, and the second host computer may calibrate the control parameter in the controller. The controller may control the height adjustment valve to be opened or closed based on the control parameter, achieving inflation and deflation of the height adjustment valve. When the controller stops changing the opened/closed state of the height adjustment valve, and when the difference between the vehicle height data collected by the sensor and the target height data is not within the preset threshold range, the first host computer may determine that the controller of the air spring is not working properly, and the first host computer may determine that the control parameter in the controller is incorrect. The first host computer may send the second instruction to the second host computer to instruct the second host computer to send the correct control parameter to the controller.

When the controller receives the CAN signal, the CAN signal may include the driving data within the safe driving data range, and the controller may control the change in the opened/closed state of the height adjustment valve based on the driving data within the safe driving data range. When the opened/closed state of the height adjustment valve is not changed, the first host computer may determine that the controller of the air spring is not working properly, and the first host computer may determine that the control parameter in the controller is incorrect. The first host computer may send the second instruction to the second host computer to instruct the second host computer to send the correct control parameter to the controller.

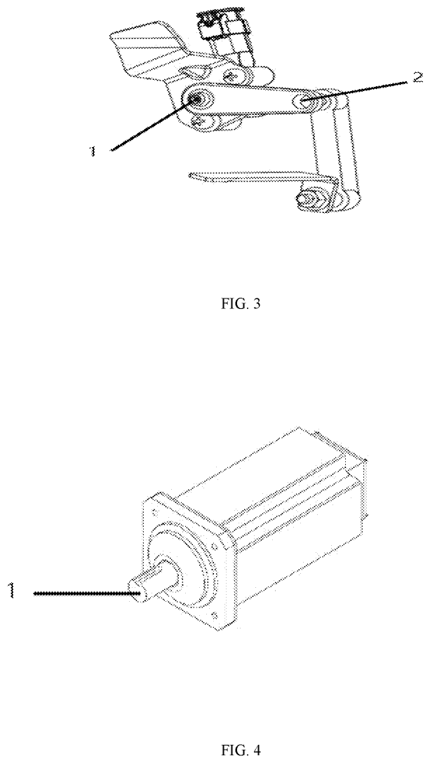

FIG. 3 is a schematic diagram of the sensor according to an embodiment of the present disclosure. The reference numeral 2 in FIG. 3 may be a connecting rod, and the reference numeral 1 in FIG. 3 may be a cylindrical structure to be inserted in the connecting rod. The sensor may disconnect the connecting rod, discarding the structure below the connecting rod in FIG. 3, so as to reduce a resistance encountered when the sensor moves.

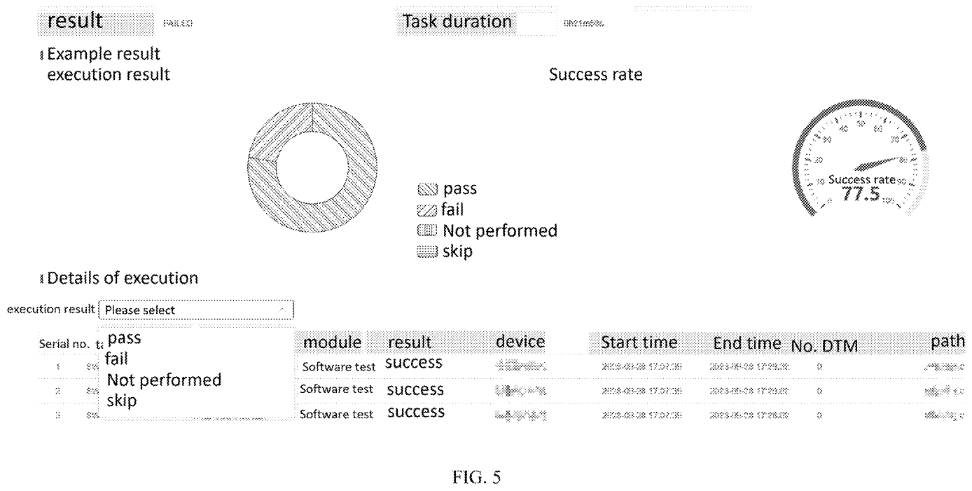

FIG. 4 shows a schematic diagram of the stepper motor according to an embodiment of the present disclosure. The stepper motor may rotate by step, by angle, by revolution, and by length. The stepper motor may also control a direction of rotation, achieving forward rotation and reverse rotation. In the embodiment of the present disclosure, the stepper motor may be connected to the sensor; the controller may control the rotation of the stepper motor to change the height of the sensor. A protruding structure indicated by the reference numeral 1 in FIG. 4 may be inserted into the cylindrical structure indicated by the reference numeral 1 in FIG. 3, so as to achieve connection between the stepper motor and the sensor. When a damping is arranged between the protruding structure indicated by the reference numeral 1 in FIG. 4 and the cylindrical structure indicated by the reference numeral 1 in FIG. 3 to affect the rotation of the stepper motor, a sealing adhesive may be used to fix the protruding structure indicated by the reference numeral 1 in FIG. 4 with the cylindrical structure indicated by the reference numeral 1 in FIG. 3.

In the embodiment of the present disclosure, the test system for the controller of the vehicle air spring may include four sensors and four stepper motors connected to the four sensors. Each of the four sensors may be connected to a respective one of the four stepper motors. Lower parts of the four sensors may be fixed to each other by one acrylic plate, and the four stepper motors may be fixed to each other by one acrylic plate.

FIG. 5 is a schematic diagram of test results output by the first host computer according to an embodiment of the present disclosure.

In the embodiment of the present disclosure, the first host computer may output the test results and a test success rate output by the test system for the controller of the vehicle air spring. The test results may include success, failure, skipped, and not executed, avoiding any error caused by the user manually recording test results, and the user may perform the testing conveniently.

In an example, after the second host computer sends the target height data to the controller, the controller may not change the mode of the air spring, and the target height data stored in the controller may not be changed to the target height data sent by the second host computer. When the controller stops changing the opened/closed state of the height adjustment valve, and when the difference between the target height data and the vehicle height data collected by the sensor is out of the preset threshold range, the first host computer may determine that the controller of the air spring is not working properly, and the test result output by the first host computer may be failure.

It should be noted that, for the method embodiments, in order to provide simplified description, a series of operation combinations may be provided, but any ordinary skilled artisan in the art shall understand that the embodiments of the present disclosure are not limited by the described order of operation. According to the embodiments of the present disclosure, certain operations may be performed in other orders or simultaneously. Secondly, any ordinary skilled artisan in the art shall understand that the embodiments described in the specification are preferred embodiments, and the operations described therein may not be necessarily required by the embodiments of the present disclosure.

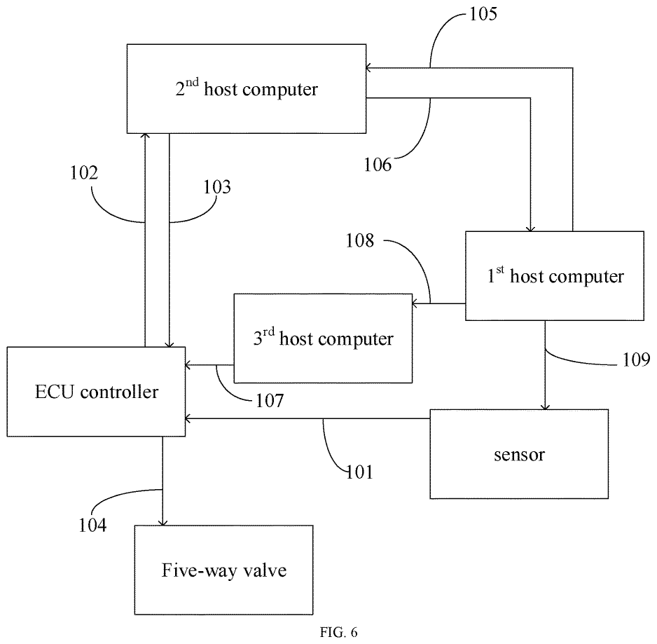

FIG. 6 is a structural block diagram of the test system for the controller of the vehicle air spring according to an embodiment of the present disclosure.

The test system for the controller of the vehicle air spring may include the first host computer, the air spring, and the stepper motor. The air spring may include an ECU controller, the second host computer, the third host computer, the sensor, and the five-way valve. The five-way valve may be the height adjustment valve. The first host computer may be communicatively connected to the ECU controller, the second host computer, the third host computer, and the stepper motor; and the stepper motor may be connected to the sensor. The first host computer may store a program written by the user in Python. Python may be an object-oriented, interpreted computer programming language. The first host computer may use the program to enable rotation of the stepper motor and sending of the CAN signal to be performed automatically. The sensor may be configured to collect the vehicle height data and to perform the block 101 where the vehicle height data may be sent to the ECU controller.

The second host computer may collect the opened/closed state information of the five-way valve. The second host computer may perform the block 202 in which the vehicle driving data and the target height data stored in the ECU controller may be collected. The second host computer may perform the block 106 in which the vehicle driving data, the target height data, and the opened/closed state information of the five-way valve may be sent to the first host computer. The first host computer may determine whether the vehicle driving data is within the preset data range. When the vehicle driving data is not within the preset data range, the first host computer may perform the block 108 in which the second instruction may be sent to the third host computer to instruct the third host computer to perform the block 107 to send the CAN signal to the ECU controller. The CAN signal may include the driving data within the safe driving data range. When the ECU controller receives the CAN signal, the ECU controller may change the opened/closed state of the five-way valve.

The first host computer may perform the block 105 in which the instruction may be sent to the second host computer to instruct the second host computer to perform the block 103 to send the target height data to the ECU controller, so as to change the mode of the air spring. The ECU controller may perform the block 104 in which the opened/closed state of the five-way valve may be changed based on the vehicle height data sent by the sensor and the target height data sent by the second host computer, such that inflation and deflation of the five-way valve may be achieved.

The first host computer may perform the block 109 in which rotation of the stepper motor may be controlled according to the opened/closed state of the five-way valve, so as to change the height of the sensor. When the vehicle height data received by the ECU controller from the sensor is equal to the target height data, the ECU controller may stop changing the opened/closed state of the five-way valve, and the first host computer may accordingly stop controlling the rotation of the stepper motor. When the ECU controller stops changing the opened/closed state of the five-way valve and the first host computer stops controlling the rotation of the stepper motor, the first host computer may obtain, from the air spring, the vehicle height data that is collected by the sensor when the ECU controller stops changing the opened/closed state of the five-way valve. The first host computer may calculate the difference between the target height data and the vehicle height data collected by the sensor when the ECU controller stops changing the opened/closed state of the five-way valve, and may determine whether the difference is within the preset threshold range. When the difference is within the preset threshold range, the first host computer may determine that the ECU controller of the air spring is working properly.

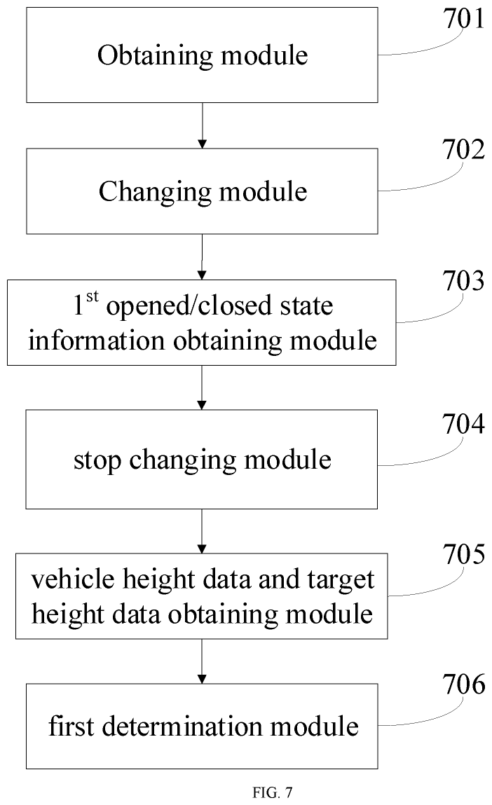

As shown in FIG. 7, a structural block diagram of a test apparatus for the controller of the vehicle air spring according to an embodiment of the present disclosure is shown. The apparatus may be applied to the test system for the controller of the vehicle air spring. The test system for the controller of the vehicle air spring at least may include the air spring, the stepper motor, and the first host computer communicatively connected to the air spring. The air spring may at least include the controller, the sensor, and the height adjustment valve. The controller may be configured to control the height adjustment valve. The stepper motor may be connected to the sensor. The sensor may be configured to collect the vehicle height data. The apparatus may specifically include the following modules.

An obtaining module 701 may be configured to cause the controller to obtain, from the air spring, the vehicle height data and the preset target height data

A changing module 702 may be configured to cause the controller to change the opened/closed state of the height adjustment valve based on the vehicle height data and the target height data.

A first opened/closed state information obtaining module 703 may be configured to cause the first host computer to: obtain the opened/closed state information of the height adjustment valve from the air spring; and operate, based on the opened/closed state information, the stepper motor to change the height of the sensor.

A stop changing module 704 may be configured to cause, when the vehicle height data obtained by the controller from the sensor is equal to the target height data, the controller to stop changing the opened/closed state of the height adjustment valve.

A vehicle height data and target height data obtaining module 705 may be configured to cause the first host computer to obtain the vehicle height data and the target height data from the air spring, and determine whether the difference between the vehicle height data and the target height data is within the preset threshold range.

A first determination module 706 may be configured to cause, when the difference between the vehicle height data and the target height data is within the preset threshold range, the first host computer to determine that the controller of the air spring is working properly.

In an embodiment of the present disclosure, the air spring may further include a second host computer. The second host computer may be communicatively connected to the controller. The apparatus may further include the following.

A driving data obtaining module may be configured to cause the first host computer to: obtain the driving data from the air spring; and determine whether the driving data is within the preset data range.

A first instruction sending module may be configured to cause, when the driving data is within the preset data range, the first host computer to send the first instruction to the second host computer. The first instruction may be configured to instruct the second host computer to send the target height data to the controller.

A first instruction receiving module may be configured to cause the second host computer to: receive the first instruction; and send, based on the first instruction, the target height data to the controller.

In an embodiment of the present disclosure, the driving data obtaining module may further include the following.

A driving data collection submodule may be configured to cause the second host computer to: collect the driving data from the controller; and send the driving data to the first host computer.

A driving data receiving sub-module may be configured to cause the first host computer to receive the driving data sent by the second host computer.

In an embodiment of the present disclosure, the air spring may further include the third host computer. The third host computer may be communicatively connected to the controller. The changing module may further include the following.

A second instruction sending submodule may be configured to cause, when the driving data is not within the preset data range, the first host computer to send the second instruction to the third host computer. The second instruction may be configured to instruct the third host computer to send preset driving data that is within the data range to the controller.

A second instruction receiving submodule may be configured to cause the third host computer to: receive the second instruction; and send, based on the second instruction, the preset driving data that is within the data range to the controller.

A changing sub-module may be configured to cause, when the controller receives the driving data that is within the data range, the controller to change the opened/closed state of the height adjustment valve based on the vehicle height data and the target height data.

In an embodiment of the present disclosure, the apparatus may further include the following.

A determination module may be configured to, when the controller receives the driving data that is within the data range, cause the first host computer to determine, based on the opened/closed state information, whether the opened/closed state of the height adjustment valve is changed.

A second determination module may be configured to, when the opened/closed state of the height adjustment valve is changed, cause the first host computer to determine that the controller of the air spring is working properly.

In an embodiment of the present disclosure, the vehicle height data and target height data obtaining module may further include the following.

A sending sub-module may be configured to cause the second host computer to: collect the vehicle height data and the target height data from the controller; and send the vehicle height data and the target height data to the first host computer.

A receiving sub-module may be configured to cause the first host computer to receive the vehicle height data and the target height data sent by the second host computer.

In an embodiment of the present disclosure, the controller may further store the control parameter. The apparatus may further include the following.

A third determination module may be configured to cause, when the difference between the vehicle height data and the target height data is not within the preset threshold range and/or the opened/closed state of the height adjustment valve is not changed, the first host computer to determine that the control parameter is incorrect.

A third instruction sending module may be configured to cause the first host computer to send the third instruction to the second host computer. The third instruction may be configured to instruct the second host computer to send the correct preset control parameter to the controller.

A third instruction receiving module may be configured to cause the second host computer to: receive the third instruction; and send, based on the third instruction, the correct preset control parameter to the controller.

The apparatus embodiment may be substantially similar to the method embodiment, and therefore, the description of the apparatus embodiment may be relatively brief. Relevant aspects may be referred to the description of the method embodiment.

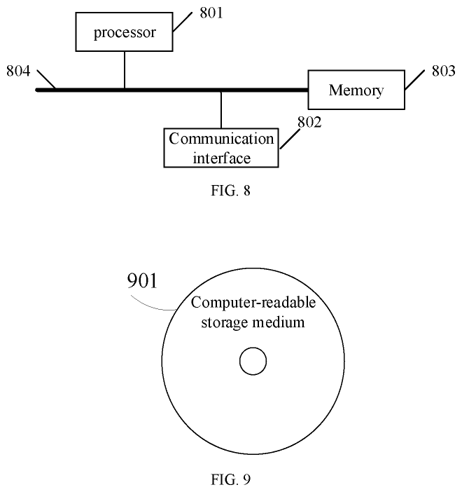

In addition, an embodiment of the present disclosure may further provide an electronic device, as shown in FIG. 8, including a processor 801, a communication interface 802, a memory 803, and a communication bus 804. The processor 801, the communication interface 802, and the memory 803 may communicate with each other via the communication bus 804.

The memory 803 may be configured to store computer programs.

The processor 801 may be configured to execute the programs stored in the memory 803 to implement the following operations.

The controller may obtain, from the air spring, the vehicle height data and the preset target height data.

The controller may change the opened/closed state of the height adjustment valve based on the vehicle height data and the target height data.

The first host computer may obtain the opened/closed state information of the height adjustment valve from the air spring, and operate, based on the opened/closed state information, the stepper motor to change the height of the sensor.

When the vehicle height data obtained by the controller from the sensor is equal to the target height data, the controller may stop changing the opened/closed state of the height adjustment valve.

The first host computer may obtain the vehicle height data and the target height data from the air spring, and determine whether the difference between the vehicle height data and the target height data is within the preset threshold range.

When the difference between the vehicle height data and the target height data is within the preset threshold range, the first host computer may determine that the controller of the air spring is working properly.

In an embodiment of the present disclosure, the air spring may further include the second host computer. The second host computer is communicatively connected to the controller. The method further include the following.

The first host computer may obtain the driving data from the air spring, and determin whether the driving data is within the preset data range.

When the driving data is within the preset data range, the first host computer may send the first instruction to the second host computer; and the first instruction may be configured to instruct the second host computer to send the target height data to the controller.

The second host computer may receive the first instruction, and send, based on the first instruction, the target height data to the controller.

In an embodiment of the present disclosure, the operation of obtaining driving data may further include the following.

The second host computer may collect the driving data from the controller, and send the driving data to the first host computer.

The first host computer may receive the driving data sent by the second host computer.

In an embodiment of the present disclosure, the air spring may further include the third host computer. The third host computer may be communicatively connected to the controller. The operation of changing the opened/closed state of the height adjustment valve based on the vehicle height data and the target height data, may further include the following.

When the driving data is not within the preset data range, the first host computer may send the second instruction to the third host computer. The second instruction may be configured to instruct the third host computer to send the preset driving data that is within the data range to the controller.

The third host computer may receive the second instruction, and send, based on the second instruction, the preset driving data that is within the data range to the controller.

When the controller receives the driving data that is within the data range, the controller may change the opened/closed state of the height adjustment valve based on the vehicle height data and the target height data.

In an embodiment of the present disclosure, the method may further include the following.

When the controller receives the driving data that is within the data range, the first host computer may determine, based on the opened/closed state information, whether the opened/closed state of the height adjustment valve is changed.

When the opened/closed state of the height adjustment valve is changed, the first host computer may determine that the controller of the air spring is working properly.

In an embodiment of the present disclosure, the operation of obtaining the vehicle height data and the target height data, may further include the following.

The second host computer may collect the vehicle height data and the target height data from the controller, and send the vehicle height data and the target height data to the first host computer.

The first host computer may receive the vehicle height data and the target height data sent by the second host computer.

In an embodiment of the present disclosure, the controller may further store the control parameter. The method may further include the following.

When the difference between the vehicle height data and the target height data is not within the preset threshold range, and/or when the opened/closed state of the height adjustment valve is not changed, the first host computer may determine that the control parameter is incorrect.

The first host computer may send the third instruction to the second host computer. The third instruction may be configured to instruct the second host computer to send preset correct control parameter to the controller.

The second host computer may receive the third instruction, and send, based on the third instruction, the preset correct control parameter to the controller.

The communication bus in the above apparatus may be a peripheral component interconnect (PCI) bus or an extended industry standard architecture (EISA) bus, and so on. The communication bus may include an address bus, a data bus, a control bus, and so on. For representation, only one thick line is used in the drawings, but the one thick line does not mean there is only one bus or one type of buses.

The communication interface may be used for communication between the above apparatus and other devices.

The memory may include a random access memory (RAM) or a non-volatile memory, such as at least one disk memory. In some embodiments, the memory may be at least one storage device that is located remotely from the aforementioned processor.

The above processor may be a general-purpose processor, including a central processing unit (CPU), a network processor (NP), and so on. Alternatively, the processor may be a digital signal processor (DSP), an application specific integrated circuit (ASIC), a field-programmable gate array (FPGA) or any other programmable logic device, a discrete gate or transistor logic device, or a discrete hardware component.

In another embodiment, FIG. 9 shows a computer-readable storage medium 901. The computer-readable storage medium may store instructions which, when being executed on a computer, cause a computer to perform the testing method for the controller of the vehicle air spring described in the above embodiments.

Another embodiment of the present disclosure may provide a computer program product containing instructions. When the computer program product is run on a computer, the computer may be caused to perform the testing method for the controller of the vehicle air spring described in the above embodiments.

All or part of the above embodiments may be implemented by software, hardware, firmware, or any combination thereof. When implemented by software, all or part of the above embodiments may be implemented in a form of a computer program product. The computer program product may include one or more computer instructions. When the computer program instructions are loaded and executed on the computer, processes or functions according to the embodiments of the present disclosure may be all or partially generated. The computer may be a general-purpose computer, a special-purpose computer, a computer network, or any other programmable device. The computer instructions may be stored in the computer-readable storage medium or transmitted from one computer-readable storage medium to another computer-readable storage medium. For example, the computer instructions may be transmitted from one website, one computer, one server, or one data center to another website, another computer, another server, or another data center by wires (such as a coaxial cable, an optical fiber, a digital subscriber line (DSL)) or wirelessly (such as infrared, wireless, microwave, and so on). The computer-readable storage medium may be any available medium that can be accessed by the computer, or a data storage device such as a server or a data center that includes one or more available media integrated together. The available medium may be a magnetic medium (such as a floppy disk, a hard disk, a tape), an optical medium (such as DVD), or a semiconductor medium (such as a solid state disk (SSD)), and so on.

It should be noted that, in the present disclosure, relational terms such as “first” and “second” are used merely to distinguish one entity or operation from another entity or operation, and do not necessarily require or imply any actual relationship or order between the entities or operations. Moreover, the terms “include”, “comprise”, or any other variants thereof are intended to cover non-exclusive inclusion. Therefore, a process, a method, an article, or a device that includes a series of elements includes not only the listed elements but also other elements that are not expressly listed, or includes elements that are inherently included in the process, the method, the article, or the device. Without further limitation, an element defined by the phrase “including a . . . ” does not exclude presence of another identical element in the process, the method, the article, or the device that includes the element.

Embodiments in the present specification are described in relation to each other, and same and similar parts of the embodiments may be referred to each other. Each embodiment may focus on differences from other embodiments. In particular, for the system embodiment, since it is basically similar to the method embodiment, the description may be relatively brief; any relevant aspect may be referred to the description of the method embodiment.

The above description is only preferred embodiments of the present disclosure and is not intended to limit the scope of the present disclosure. Any modifications, equivalent substitutions, improvements, and so on, made within the spirit and principles of the present disclosure shall be included within the scope of the present disclosure.

What is claimed is:

1. A testing method for a controller of a vehicle air spring, applied to a test system for the controller of the vehicle air spring; the test system for the controller of the vehicle air spring at least comprising an air spring, a stepper motor, and a first host computer communicatively connected to the air spring; the air spring at least comprising a controller, a sensor, and a height adjustment valve; the controller being configured to control the height adjustment valve; the stepper motor being connected to the sensor; the sensor being configured to collect vehicle height data; the method comprising:
obtaining, by the controller from the air spring, the vehicle height data and preset target height data;
changing, by the controller, an opened/closed state of the height adjustment valve based on the vehicle height data and the target height data;
obtaining, by the first host computer from the air spring, opened/closed state information of the height adjustment valve; and operating, based on the opened/closed state information, the stepper motor to change the height of the sensor;
the controller stopping changing the opened/closed state of the height adjustment valve, when the vehicle height data obtained by the controller from the sensor being equal to the target height data;
obtaining, by the first host computer from the air spring, the vehicle height data and the target height data; and determining whether a difference between the vehicle height data and the target height data is within a preset threshold range; and
the first host computer determining that the controller of the air spring is working properly, when the difference between the vehicle height data and the target height data being within the preset threshold range.

2. The testing method according to claim 1, wherein, the air spring further comprises a second host computer; the second host computer is communicatively connected to the controller; and the method further comprises:
the first host computer obtaining driving data from the air spring, and determining whether the driving data is within a preset data range;
the first host computer sending, when the driving data being within the preset data range, a f irst instruction to the second host computer; wherein, the first instruction is configured to instruct the second host computer to send the target height data to the controller;
the second host computer receiving the first instruction; and sending, based on the first instruction, the target height data to the controller.

3. The testing method according to claim 2, wherein, the first host computer obtaining driving data from the air spring, comprises:
the second host computer collecting the driving data from the controller, and sending the driving data to the first host computer; and
the first host computer receiving the driving data sent by the second host computer.

4. The testing method according to claim 2, wherein, the air spring further comprises a third host computer; the third host computer is communicatively connected to the controller; and the changing an opened/closed state of the height adjustment valve based on the vehicle height data and the target height data, comprises:
the first host computer sending, when the driving data being not within the preset data range, a second instruction to the third host computer; wherein, the second instruction is configured to instruct the third host computer to send preset driving data that is within the data range to the controller;
the third host computer receiving the second instruction; and sending, based on the second instruction, the preset driving data that is within the data range to the controller; and
when the controller receiving the driving data that is within the data range, the controller changing the opened/closed state of the height adjustment valve based on the vehicle height data and the target height data.

5. The testing method according to claim 4, further comprising:
when the controller receiving the driving data that is within the data range, the first host computer determining, based on the opened/closed state information, whether the opened/closed state of the height adjustment valve is changed; and
when the opened/closed state of the height adjustment valve being changed, the first host computer determining that the controller of the air spring is working properly.

6. The testing method according to claim 2, wherein, the obtaining the vehicle height data and preset target height data, comprises:
the second host computer collecting the vehicle height data and the target height data from the controller, and sending the vehicle height data and the target height data to the first host computer; and
the first host computer receiving the vehicle height data and the target height data sent by the second host computer.

7. The testing method according to claim 5, wherein, the controller further stores a control parameter; and the method further comprises:
the first host computer determining that the control parameter is incorrect, when the difference between the vehicle height data and the target height data being not within the preset threshold range, and/or when the opened/closed state of the height adjustment valve being not changed;
the first host computer sending a third instruction to the second host computer; wherein, the third instruction is configured to instruct the second host computer to send a correct preset control parameter to the controller; and
the second host computer receiving the third instruction; and sending, based on the third instruction, the correct preset control parameter to the controller.

8. An electronic device, comprising a processor, a communication interface, a memory, and a communication bus, wherein the processor, the communication interface, and the memory communicate with each other via the communication bus;
the memory is configured to store computer programs; and
the processor is configured to execute the programs stored in the memory to implement a testing method for a controller of a vehicle air spring; wherein, the testing method is applied to a test system comprising an air spring, a stepper motor, and a first host computer communicatively connected to the air spring; the air spring at least comprises a controller, a sensor, and a height adjustment valve; the controller is configured to control the height adjustment valve; the stepper motor being connected to the sensor; the sensor is configured to collect vehicle height data; the testing method comprises:
obtaining, by the controller from the air spring, the vehicle height data and preset target height data;
changing, by the controller, an opened/closed state of the height adjustment valve based on the vehicle height data and the target height data;
obtaining, by the first host computer from the air spring, opened/closed state information of the height adjustment valve; and operating, based on the opened/closed state information, the stepper motor to change the height of the sensor;
the controller stopping changing the opened/closed state of the height adjustment valve, when the vehicle height data obtained by the controller from the sensor being equal to the target height data;
obtaining, by the first host computer from the air spring, the vehicle height data and the target height data; and determining whether a difference between the vehicle height data and the target height data is within a preset threshold range; and
the first host computer determining that the controller of the air spring is working properly, when the difference between the vehicle height data and the target height data being within the preset threshold range.

9. The electronic device according to claim 8, wherein, the air spring further comprises a second host computer; the second host computer is communicatively connected to the controller; and the processor is further configured to execute the programs to implement:
the first host computer obtaining driving data from the air spring, and determining whether the driving data is within a preset data range;
the first host computer sending, when the driving data being within the preset data range, a f irst instruction to the second host computer; wherein, the first instruction is configured to instruct the second host computer to send the target height data to the controller;
the second host computer receiving the first instruction; and sending, based on the first instruction, the target height data to the controller.

10. The electronic device according to claim 9, wherein, the first host computer obtaining driving data from the air spring, comprises:
the second host computer collecting the driving data from the controller, and sending the driving data to the first host computer; and
the first host computer receiving the driving data sent by the second host computer.

11. The electronic device according to claim 9, wherein, the air spring further comprises a third host computer; the third host computer is communicatively connected to the controller; and the changing an opened/closed state of the height adjustment valve based on the vehicle height data and the target height data, comprises:
the first host computer sending, when the driving data being not within the preset data range, a second instruction to the third host computer; wherein, the second instruction is configured to instruct the third host computer to send preset driving data that is within the data range to the controller;
the third host computer receiving the second instruction; and sending, based on the second instruction, the preset driving data that is within the data range to the controller; and
when the controller receiving the driving data that is within the data range, the controller changing the opened/closed state of the height adjustment valve based on the vehicle height data and the target height data.

12. The electronic device according to claim 11, wherein, the processor is further configured to execute the programs to implement:
when the controller receiving the driving data that is within the data range, the first host computer determining, based on the opened/closed state information, whether the opened/closed state of the height adjustment valve is changed; and
when the opened/closed state of the height adjustment valve being changed, the first host computer determining that the controller of the air spring is working properly.

13. The electronic device according to claim 9, wherein, the obtaining the vehicle height data and preset target height data, comprises:
the second host computer collecting the vehicle height data and the target height data from the controller, and sending the vehicle height data and the target height data to the first host computer; and
the first host computer receiving the vehicle height data and the target height data sent by the second host computer.

14. A test system for a controller of a vehicle air spring, at least comprising an air spring, a stepper motor, and a first host computer communicatively connected to the air spring; the air spring at least comprising a controller, a sensor, and a height adjustment valve; the controller being configured to control the height adjustment valve; the stepper motor being connected to the sensor; the sensor being configured to collect vehicle height data;
wherein, the test system for the controller of the vehicle air spring further comprises a processor, a communication interface, a memory, and a communication bus; wherein the processor, the communication interface, and the memory communicate with each other via the communication bus;
the memory is configured to store computer programs;
the processor is configured to execute the programs stored in the memory to implement a testing method for the controller of the vehicle air spring, and the testing method comprises:
the controller obtaining, from the air spring, the vehicle height data and preset target height data;
the controller changing an opened/closed state of the height adjustment valve based on the vehicle height data and the target height data;
the first host computer obtaining, from the air spring, opened/closed state information of the height adjustment valve; and operating, based on the opened/closed state information, the stepper motor to change the height of the sensor;
when the vehicle height data obtained by the controller from the sensor being equal to the target height data, the controller stopping changing the opened/closed state of the height adjustment valve;
the first host computer obtaining, from the air spring, the vehicle height data and the target height data; and determining whether a difference between the vehicle height data and the target height data is within a preset threshold range; and
when the difference between the vehicle height data and the target height data being within the preset threshold range, the first host computer determining that the controller of the air spring is working properly.

15. The test system according to claim 14, wherein the air spring further comprises a second host computer; the second host computer is communicatively connected to the controller; the testing method further comprises:
the first host computer obtaining driving data from the air spring, and determining whether the driving data is within a preset data range;
when the driving data being within the preset data range, the first host computer sending a first instruction to the second host computer; wherein the first instruction is configured to instruct the second host computer to send the target height data to the controller; and
the second host computer receiving the first instruction; and sending, based on the first instruction, the target height data to the controller.

16. The test system according to claim 15, wherein the obtaining driving data further comprises:
the second host computer collecting the driving data from the controller, and sending the driving data to the first host computer; and
the first host computer receiving the driving data sent by the second host computer.

17. The test system according to claim 15, wherein the air spring further comprises a third host computer; the third host computer is communicatively connected to the controller; the changing an opened/closed state of the height adjustment valve based on the vehicle height data and the target height data, comprises:
when the driving data being not within the preset data range, the first host computer sending a second instruction to the third host computer; wherein the second instruction is configured to instruct the third host computer to send preset driving data that is within the data range to the controller;
the third host computer receiving the second instruction; and sending, based on the second instruction, the preset driving data that is within the data range to the controller; and
when the controller receiving the driving data that is within the data range, the controller changing the opened/closed state of the height adjustment valve based on the vehicle height data and the target height data.

18. The test system according to claim 15, wherein the testing method further comprises:
when the controller receiving the driving data that is within the data range, the first host computer determining, based on the opened/closed state information, whether the opened/closed state of the height adjustment valve is changed; and
when the opened/closed state of the height adjustment valve being changed, the first host computer determining that the controller of the air spring is working properly.

19. The test system according to claim 15, wherein the obtaining the vehicle height data and preset target height data, comprises:
the second host computer collecting the vehicle height data and the target height data from the controller, and sending the vehicle height data and the target height data to the first host computer; and
the first host computer receiving the vehicle height data and the target height data sent by the second host computer.

20. The test system according to claim 18, wherein, the controller further stores a control parameter; and the testing method further comprises:
when the difference between the vehicle height data and the target height data being not within the preset threshold range, and/or when the opened/closed state of the height adjustment valve being not changed, the first host computer determining that the control parameter is incorrect; and
the first host computer sending a third instruction to the second host computer; wherein the third instruction is configured to instruct the second host computer to send a correct preset control parameter to the controller; and
the second host computer receiving the third instruction; and sending, based on the third instruction, the correct preset control parameter to the controller.
